(19) United States
(12) Patent Application Publication
(10) Pub. No.: US 2003/0181616 A1
(43) Pub. Date: Sep. 25, 2003

(54) Halogenated monomers and polymers and process for making same

(76) Inventors: Brian Thomas, Exton, PA (US); Jingsong Zhu, Phoenixville, PA (US)

Correspondence Address: Finnegan, Henderson, Farabow,, Garrett & Dunner, L.L.P., 1300 I Street, N.W., Washington, DC, 20005-3315, US

(21) Appl. No.: 10/364,413

(22) Filed: Feb. 12, 2003

Related U.S. Application Data
(60) Provisional application No. 60/356,432, filed on Feb. 12, 2002.

(51) Int. Cl. C08F 114/18; C08F 136/16

(52) U.S. Cl. 526/252; 526/250

(57) ABSTRACT

The present invention embodies halogenated compounds that can be used as monomer units in a variety of polymeric compositions. Processes for making the monomers and polymers are provided.

### CROSS-REFERENCE TO RELATED APPLICATION

This application claims the benefit of priority under 35 U.S.C. §119(e) to U.S. Provisional Application No. 60/356,432 filed Feb. 12, 2002.

### FIELD OF THE INVENTION

The present invention is directed to halogenated monomers and polymers, and processes for making the halogenated monomers and polymers.

### BACKGROUND OF THE INVENTION

Halogenated polymers, including fluoropolymers, are well known and widely used because of their unusual combination of chemical resistance, surface characteristics, dielectric properties and high-temperature service capabilities. Depending on the chemical composition, halogenated polymers may be partially crystalline or amorphous.

U.S. Pat. No. 5,350,821 reports semi-crystalline fluoropolymers made from fluorinated omega alkenyl vinyl ethers. The present invention provides a series of novel halogenated monomers and polymers, that are amorphous and contain functional groups, useful in a variety of applications such as coatings, encapsulation, and molded or extruded objects.

### SUMMARY OF THE INVENTION

The general nature of the invention pertains to novel monomers and polymers made from the novel monomers. The present invention embodies halogenated compounds that can be used as monomer units in a variety of polymeric compositions. Processes for making the monomers and polymers are provided.

In one embodiment, compounds are provided according to the formula:

R₁—(CX₄X₅)ₙ—(CX₆X₇)ₘ—(CX₈X₉)ₚ—(CX₁₀X₁₁)_{q}—R₂ (I)

where:

R₁ is X₂X₃C═CX₅— or X₁X₂X₃C—CX₄X₅—;

R₂ is —X₁₁C═CX₁₂X₁₃, —X₁₀X₁₁CH₂—CX₁₂ X₁₃X₁₄, —CX₁₂X₁₃X₁₄, F, Cl, Br or H;

wherein:

(a) X₁-X₁₄ can be the same or different and are chosen from F, Cl, Br and H, and one of X₂, X₃, X₅, X₆ or X₇ is not F, or one of X₈, X₉, X₁₁, X₁₂ or X₁₃ is not H;

(b) n, m, p and q can be the same or different and are integers from 0 to 3, with the proviso that at least one of n, m, p, or q, is not equal to zero; and

(c) at least one of R₁ or R₂ is unsaturated.

In one embodiment compounds are provided according to the formula:

R₁—(CX₄X₅)ₙ—(CX₁₅X₁₆)ₘ—(CX₈X₉)ₚ—Z—(CX₁₀X₁₁)_{q}—R₂ (II)

where:

R₁ is X₂X₃C═CX₅— or X₁X₂X₃C—CX₄X₅—;

R₂ is —X₁₁C═CX₁₂X₁₃, —X₁₀X₁₁CH₂—CX₁₂ X₁₃X₁₄, —CX₁₂X₁₃X₁₄, —CX₁₂X₁₃X₁₄, F, Cl, Br or H;

wherein:

(a) X₁, X₂, X₃, X₄, X₅, X₈, X₉, X₁₀, X₁₁, X₁₂, X₁₃, X₁₄ can be the same or different and are chosen from F, Cl, Br and H;

(b) m, p and q can be the same or different and are integers from 0 to 3;

(c) n is 1, 2 or 3;

(d) X₁₅ and X₁₆ can be the same or different and are chosen from F, Cl, Br, H and CF₃;

(e) Z is chosen from Oxygen (O), Sulfur (S), Selenium (Se), and Tellurium (Te); and

(f) at least one of R₁ or R₂ is unsaturated.

In another embodiment compounds are provided according to the formula:

R₁—Z—(CX₁₅X₁₆)ₙ—(CX₈X₉)ₘ—(CX₁₀X₁₁)ₚ—Z—R₂ (III)

where:

R₁ is X₂X₃C═CX₅— or X₁X₂X₃C—CX₄X₅—;

R₂ is —X₁₁C═CX₁₂X₁₃, —X₁₀X₁₁CH₂—CX₁₂X₁₃X₁₄, —CX₁₂X₁₃X₁₄, F, Cl, Br or H;

wherein:

(a) Z is chosen from O, S, Se, and Te;

(b) X₁, X₂, X₃, X₄, X₅, X₈, X₉, X₁₀, X₁₁, X₁₂, X₁₃, X₁₄ can be the same or different and are chosen from F, Cl, Br and H;

(c) X₁₅ and X₁₆ can be the same or different and are chosen from F, Cl, Br, H and CF₃; (d) n, m, and p can be the same or different and are integers from 0 to 3;

(e) at least one of n, m, or p is not equal to zero; and

(f) at least one of R₁ or R₂ is unsaturated.

In another exemplary embodiment compounds are provided according to the formula

R₁—(CX₄X₅)ₙ—Z—(CX₆X₇)ₘ—Z—(CX₈X₉)ₚ—Z—(CX₁₀X₁₁)_{q}—R₂ (IV)

where:

R₁ is X₂X₃C═CX₅— or X₁X₂X₃C—CX₄X₅—;

R₂ is —X₁₁C═CX₁₂X₁₃, —X₁₀X₁₁CH₂—CX₁₂X₁₃X₁₄, —CX₁₂X₁₃X₁₄ F, Cl, Br or H;

wherein:

(a) at least one of R1 or R2 is unsaturated;

(b) X₁-X₁₄ can be the same or different and are chosen from F, Cl, Br and H;

(c) X₁₅ and X₁₆ can be the same or different and are chosen from F, Cl, Br, H and CF₃; (d) n, m, p and q can be the same or different and are integers from 1 to 3; and

(e) Z is chosen from O, S, Se, and Te.

In another embodiment, a polymer is disclosed wherein at least one monomer of the polymer is chosen from a compound from formula (I), formula (II), formula (III), formula (IV).

In another embodiment, a method of making the polymer is disclosed. The process comprises (a) mixing in a suitable solvent an initiator with at least one first monomer which is selected from the compounds of formula (I), formula (II), formula (III) and formula (IV); (b) optionally adding a second monomer which is different from said first monomer; (c) heating for 1-5 days at a temperature of 25-200° C.; and (d) recovering the polymer; whereby oxygen is removed prior to the start of the reaction.

### DETAILED DESCRIPTION OF THE INVENTION

This invention concerns halogenated monomers and polymers of such monomers made by free radical polymerization. The polymers are soluble in selected common organic solvents and they are suited for films, coatings, and molded or extruded articles.

In one embodiment, monomers are represented by formula (I):

R₁—(CX₄X₅)ₙ—(CX₆X₇)ₘ—(CX₈X₉)ₚ—(CX₁₀X₁₁)_{q}—R₂ (I)

where:

R₁ is X₂X₃C═CX₅— or X₁X₂X₃C—CX₄X₅—;

R₂ is —X₁₁C═CX₁₂X₁₃, —X₁₀X₁₁CH₂—CX₁₂ X₁₂X₁₃X₁₄, —CX₁₂X₁₃X₁₄, F, Cl, Br or H;

wherein:

(a) X₁-X₁₄ can be the same or different and are chosen from F, Cl, Br and H, and one of X₂, X₃, X₅, X₆ or X₇ is not F, or one of X₈, X₉, X₁₁, X₁₂ or X₁₃ is not H;

(b) n, m, p and q can be the same or different and are integers from 0 to 3, with the proviso that at least one of n, m, p, or q, is not equal to zero; and

(c) at least one of R₁ or R₂ is unsaturated.

In another embodiment of compound I described above,

R₁ is X₂X₃C═CX₅; R₂ is —X₁₁C═CX₁₂X₁₃;

X₂, X₃, X₅, X₁₁, X₁₂ and X₁₃ are F; X₆, and X₇ are H; n=p=q=0; and m=4, yielding the compound CF₂═CF(CH₂)₄CF═CF₂.

In one embodiment, compounds are represented by formula (II):

R₁—(CX₄X₅)ₙ—(CX₁₅X₁₆)ₘ—(CX₈X₉)ₚ—Z—(CX₁₀X₁₁)_{q}—R₂ (II)

wherein:

(a) R₁, R₂, X₁, X₂, X₃, X₄, X₅, X₈, X₉, X₁₀, X₁₁, X₁₂, X₁₃, X₁₄, m, p and q have the same meaning indicated in formula (I);

(b) X₁₅ and X₁₆ can be the same or different and are chosen from F, Ci, Br, H and CF₃;

(c) Z is chosen from O, S, Se, and Te; and

(d) n is 1, 2 or 3.

In another embodiment of formula (II):

(a) X₁₅ and X₁₆ are F;

(b) m=1, 2 or 3; p=1; q=n=0;

(c) X₈ and X₉ can be the same or different and are chosen from H, F and Cl;

(d) R₁ is X₂X₃C═CX₅— or X₁X₂X₃C—CX₄X₅— where X₂, X₃, and X₅=F, and X₁ and X₄=Cl; and

(e) R₂ is —X₁₁C═CX₁₂X₁₃ where X₁₁ and X₁₂ are F, and X₁₃ is Br or Cl.

In another embodiment of formula (II),

(a) R₁ is X₁X₂X₃C—CX₄X₅—;

(b) R₂ is —X₁₁C═CX₁₂X₁₃;

(c) X₂, X₃, X₄, X₅, X₁₁ and X₁₂ are F;

(d) X₁, X₁₅ and X₁₆ are H and X₁₃ is Cl;

(e) p=q=0; m=1; n=2; and;

(f) Z is O,

yielding the compound HCF₂(CF₂)₃CH₂OCF═CFCl.

In another embodiment of formula (II),

(a) R₁ is X₂X₃C═CX₅—;

(b) R₂ is —X₁₁C═CX₁₂X₁₃;

(c) X₂, X₃, X₄, X₅, X₁₁, and X₁₂ are F;

(d) X₁₅ and X₁₆ are H; X₁₃ is Cl; Z is O; p=q=0; m=1; and n=2, yielding the compound CF₂═CF(CF₂)₂CH₂OCF═CFCl.

In one embodiment, compounds are represented by formula (III):

R₁—Z—(CX₁₅X₁₆)ₙ—(CX₈X₉)ₘ—(CX₁₀X₁₁)ₚ—Z—R₂ (III)

where R₁, R₂, X₁, X₂, X₃, X₄, X₅, X₈, X₉, X₁₀, X₁₁, X₁₂, X₁₃, X₁₄, X₁₅, X₁₆, Z, n, m, and p have the same meaning indicated in formula (I);

In another embodiment of formula (III)

(a) n=1;

(b) m=p=0; and

(c) X₁₅ and X₁₆ can be the same or different and are chosen from Cl, Br, or H, or X₁₂ and X₁₃ are the same and chosen from CH₃, Cl, Br, or H.

In another embodiment of formula (III),

(a) R₁ is X₂X₃C═CX₅—;

(b) R₂ is —X₁₁C═CX₁₂X₁₃;

(c) X₃, X₅, X₆, and X₁₃ are F;

(d) X₁₅ and X₁₆ are H; X₂ and X₁₂ are Cl; Z is O; m=p=0; and n=2,

yielding the compound CClF═CF—O(CH₂)₂O—CF═CClF.

In another embodiment of formula(III)

(a) R₁ is X₂X₃C═CX₅;

(b) R₂ is —X₁₁C═CX₁₂X₁₃;

(c) X₂, X₃, X₅, X₁₁, X₁₂ and X₁₃ are F;

(d) X₁₅ and X₁₆ are H; Z is O; m=p=0; and n=2,

yielding the compound CF₂═CF—O(CH₂)₂O—CF═CF₂.

In another embodiment of formula (III)

(a) R₁ is X₂X₃C═CX₅—;

(b) R₂ is —X₁₁C═CX₁₂X₁₃;

(c) X₂, X₃, X₁₂ and X₁₃ are F;

(d) X₅, X₁₁, X₁₅ and X₁₆ are H; Z is O; m=p=0; and n=2,

yielding the compound CF₂═CH—O(CH₂)₂O—CH═CF₂.

In an exemplary embodiment, compounds are represented by formula (IV):

R₁—(CX₄X₅)ₙ—Z—(CX₆X₇)ₘ—Z—(CX₈X₉)ₚ—Z—(CX₁₀X₁₁)_{q}—R₂ (IV)

where:

(a) R₁, R₂, X₁, X₂, X₃, X₄, X₅, X₈, X₉, X₁₀, X₁₁, X₁₂, X₁₃, X₁₄, Z, have the same meaning indicated in formula (II);

(b) n, m, p and q can be the same or different and are integers from 1 to 3.

In one embodiment of formula (IV)

(a) R₁ is X₂X₃C═CX₅.

(b) R₂ is —X₁₁C═CX₁₂X₁₃;

(c) X₂ and X₁₂ are Cl;

(d) X₃,X₅, X₁₁ and X₁₃ are F;

(e) X₆, X₇, X₈ and X₉ are H;

(f) Z is O; m=p=2; and n=q=0,

yielding the compound CFCl═CF—OCH₂CH₂OCH₂CH₂O—CF═CFCl.

The synthesis of the above-mentioned compounds can be achieved using many techniques. Typically, the alkoxide of a diol can be reacted with an alkene at reflux conditions to give the desired diene compound. The alkoxides are generally those of potassium, sodium, or lithium. The alkoxides are formed in a dry solvent such as ether or tetrahydrofuran using sodium hydride, potassium hydride, or lithium hydride at low temperatures (−60° C. to 65° C.). The alkene is then added at −65° C. and allowed to warm to room temperature over a 3-12 hour period. The desired compound can then be isolated from the above mixture and distilled to give a pure compound.

The compounds above can be used alone, together or with other monomers to make polymers. Furthermore, the compounds described above can be copolymerized with monomers containing phosphorous and/or other groups, including, but not limited to, phosphinic acid, phosphonic acid, phosphates. Other suitable comonomers include, but are not limited to, tetrafluoroethylene, hexafluoropropylene, vinylidene fluoride, perfluoro (methyl vinyl ether), perfluoro (propyl vinyl ether), methyl vinyl ether, propylene, ethylene, chlorotriflouroethylene, vinyl fluoride, vinyl chloride, trifluoroethylene, perfluoro (2, 2-dimethyl-l, 3-dioxole), CF₂═CF(CF₂)ₘOCF═CF₂, where m=1, 2 or 3, and other suitable omega-alkenyl vinyl ethers. Aluminum, scandium, yttrium and metals from the lanthanide series, such as erbium and ytterbium, can be included with these polymers to form optically “active” polymers that can be used in optical amplifiers to amplify an optical signal.

The polymers of this invention can be linear, cyclic, branched, hyperbranched, dendritic, crosslinked, random, block, graft or any structural type.

The method of making polymers from at least one of formulas (I)-(IV) can comprise (a) mixing at least one of the monomers of formula (I)-(IV) with an initiator in an optional suitable solvent, (b) optionally adding a second monomer, (c) heating for 1-5 days (or 1-4 days, or 2-3 days) at a temperature to reflux or of 25-200° C. (or 50-150° C., or 90-115° C.) and (d) polymer recovery.

In this method, the oxygen is removed prior to the start of the reaction. This removal can be performed by any number of well-known methods, including use of one or more freeze-pump-thaw cycles.

The optional suitable solvent includes any solvent that confers the polymeric synthesis. Non-limiting examples of suitable solvents include F113 (1,1,2-trichloro-1,2,2-trifluoroethane), t-butanol, water, toluene, methanol, perfluorotributylamine, perfluorotrihexylamine, perfluorotripentylamine, perfluorotripropylamine, and 1,2-dichlorohexafluoropropane.

The initiators in step (a) can be any substance capable of creating radicals, such as a peroxide, a persulfate or an azo compound. Non-limiting examples of initiators include VAZO®-88 (1,1′-azobis(cyclohexanecarbonitrile)), AIBN(2,2′-azobisisobutyronitrile, also called VAZO®-64), VAZO®-52 (2,2′-azobis (2,4-dimethyl pentanenitrile)), VAZO®-67 (2,2′-Azobis(2-methylbutyronitrile)), VAZO®-44(2,2′-azobis[2-(2-imidazolin-2-yl)propane]dichloride), VAZO®-56, VAZO®-68, tert-Amyl peroxybenzoate, 4,4-Azobis(4-cyanovaleric acid), 1,1′-Azobis (cyclohexanecarbonitrile), Benzoyl peroxide, 2,2-Bis(tert-butylperoxy)butane, 1,1-Bis(tert-butylperoxy)cyclohexane, 2,5-Bis(tertbutylperoxy)-2,5-dimethylhexane, 2,5-Bis(tert-Butylperoxy)-2,5-dimethyl-3-hexyne, Bis(1-(tert-butylperoxy)-1-methylethyl)benzene, 1,1-Bis(tert-butylperoxy)-3,3,5-trimethylcyclohexane, tert-Butyl hydroperoxide, tert-Butyl peracetate, tert-Butyl peroxide, tert-Butyl peroxybenzoate, tert-Butylperoxy isopropyl carbonate, Cumene hydroperoxide, Cyclohexanone peroxide, Dicumyl peroxide, Lauroyl peroxide, 2,4-Pentanedione peroxide, Peracetic acid, Potassium persulfate, VAZO®-70 (2,2′-azobis[4-methoxy-2,4-dimethylvaleronitrile]), VAZO®-65B (2,2′-azobis[2,4-dimethylvaleronitrile]), VAZO®-60 (2,2′-azobis[2-methylpropionitrile]), VAZO®-59 (2,2′azobis[2-methylbutyronitrile]), VAZO®-30 (1-[(1-cyano-1-methylethyl)azo]formamide, VAZO®-80 (2,2′-azobis{2-methyl-N-{1,1-bis(hydroxymethyl)-2-hydroxyethyl]propionamide), VAZO®-41 (2,2′-azobis[2-(5-methyl-2-imidazolin-2-yl)propane]dihydrochloride), VAZO®-54 (2,2′azobis(2-methylpropionamidoxime)), VAZO®-601 (dimethyl 2,2′-azobisisobutyrate),

Non-limiting examples of the second monomer in step (b) include one of the monomers of formula (I)-(IV); monomers containing phosphorous and/or other groups, including, but not limited to, phosphinic acid, phosphonic acid, phosphates; tetrafluoroethylene, hexafluoropropylene, vinylidene fluoride, perfluoro (methyl vinyl ether), perfluoro (propyl vinyl ether), methyl vinyl ether, propylene, ethylene, chlorotriflouroethylene, vinyl fluoride, vinyl chloride, trifluoroethylene, perfluoro (2, 2-dimethyl-l, 3-dioxole), and CF₂═CF(CF₂)ₘOCF═CF₂, where m=1, 2 or 3. These monomers can include aluminum (Al), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) or ytterbium (Yb).

Recovery of the polymer is performed by precipitation, filtration, extraction, centrifugation, drying, vacuum drying, or any combination thereof.

The polymers described in this invention are useful in applications including active and passive polymer waveguides, optical fibers, lenses, optical coatings, pellicles, and displays.

Reference will now be made in detail to exemplary embodiments of the invention, examples of which show that the compounds described above can be manufactured at least according to the processes described in the examples provided below:

### EXAMPLES

Example 1a

### Manufacture of CF₂═CFCH₂CH₂CH₂CH₂CF═CF₂

To a two neck 50 ml round bottom flask blanketed with nitrogen was added 25 ml dry ether, 1.30 g (53.48 mmol) magnesium, and a small iodine crystal. The mixture was stirred for 30 minutes at room temperature. To this mixture was added 20.09 g (106.31 mmol) CF₂═CFCH₂CH₂Br dropwise. The reaction was heated to reflux for 2 days. After 2 days, the reaction mixture was cooled to room temperature and 25 ml of water was added to the mixture. The mixture was extracted with ether and the ether layer dried with magnesium sulfate. The ether was removed and the product flash distilled at 2.9×10⁻³ torr and 100° C. to give 3.98 g (18.25 mmol) of clear liquid product (34.3% yield). IR (cm⁻¹) (neat, NaCl cell): 2962 (m), 2934 (m), 2875 (w), 1798 (s), 1434 (m), 1296 (s), 1245 (s), 1192 (m), 1099 (s), 1021 (m), 801 (m).

### Example 1b

### Copolymerization of CF₂═CFCH₂CH₂CH₂CH_CF═CF₂ with CF₂═CH₂

To a one neck flask equipped with a TEFLON® valve was added 50 ml F113 (1,1,2-trichloro-1,2,2,-trifluoroethane), a magnetic stir bar, 0.50 g CF₂═CFCH₂CH₂CH₂CH₂CF═CF₂ (2.29 mmol), and 0.02 g (0.08 mmol) VAZO®-88 (1,1′-azobis(cyclohexanecarbonitrile)). The flask was then cooled to −196° C. and evacuated, allowed to warm to room temperature, and the procedure repeated a total of three times. The flask was then cooled to −196° C. and 0.5 g (7.8 mmol) CF₂═CH₂ was vacuum transferred to the flask. The flask was heated to 90° C. for 3 days. After 3 days, the volatiles were vented and the solution poured into 30 ml of methanol. The polymer precipitated as a nice white material. The polymer was filtered and dried under vacuum to give 0.01 g of material. The IR shows the disappearance of the vinyl group at 1799 cm⁻¹ and the incorporation of both monomers. IR (cm¹) (neat, NaCl cell): 2962 (m), 2939 (s), 2917 (s), 2862 (m), 2849 (m), 1450 (m), 1259 (m), 1087 (m), 1013 (s) 934 (w), 864 (w), 796 (s), 746 (w).

### Example 2a

### Manufacture of CF₂═CFCF₂CF₂CH₂OCF═CFCl

In a three neck 1 L round bottom flask equipped with an addition funnel and a mechanical stirrer was placed 600 ml of dry tetrahydrofuran and 4.17 g (173.75 mmol) of sodium hydride. To the addition funnel was placed 20.09 g (86.6 mmol) H(CF₂)₄CH₂OH. The addition solution was added dropwise to the sodium hydride solution over a period of 2 hrs. After two hours, the solution was cooled to −78° C. and the flask was equipped with a −78° C. reflux condenser. To this solution was added 32 g (274.7 mmol) of CF₂═CFCl through a gas dispersion tube. The solution was allowed to react at −78° C. for 2 hrs and allowed to warm to room temperature over a 12 hr period. After 12 hrs, the solution was cooled 0° C. and 200 ml of deionized water was added dropwise. The resulting solution was extracted with ether, the ether removed, and the resulting viscous liquid distilled under vaccum to give 19.3 g (58.9 mmol) of the desired product, H(CF₂)₄CH₂OCF═CFCl.

To a 500 ml round bottom flask equipped with an addition funnel and a magnetic stirrer was transferred 200 ml of dry ether and 12.08 g (36.8 mmol) of H(CF₂)₄CH₂OCF═CFCl. To the addition funnel was transferred 43.3 ml (73.6 mmol) of t-butyl lithium and the t-butyl lithium was added dropwise to the ether solution at 0° C. over a 1 hr period. After 1 hr, the solution was allowed to warm to room temperature and react for 2 additional hrs. Then, the solution was cooled back to 0° C. and 100 ml of water was added to the flask dropwise. The ether layer was extracted, the ether removed using a rotovap, and the product distilled under vacuum to give 10.48 g (34.0 mmol) of a clear liquid (92.4% yield). IR (cm⁻¹) (neat, NaCl cell): 2973 (m), 2916 (w), 2877 (w), 1786 (w), 1757 (w), 1484 (w), 1459 (w), 1404 (w), 1367 (w), 1283 (m), 1190 (s), 1134 (s), 1088 (m), 1065 (m), 992 (w), 960 (w), 869 (w), 809 (w), 761 (w), 749 (w).

### Example 3a

### Manufacture of CFCl═CF—OCH₂CH₂O—CF—CFCl

In a three neck 1 L round bottom flask equipped with an addition funnel and a mechanical stirrer was placed 600 ml of dry tetrahydrofuran and 16.0 g (666.67 mmol) of sodium hydride. To the addition funnel was placed 13.80 g (222.33 mmol) anhydrous HOCH₂CH₂OH dissolved in 20 ml of dry tetrahydrofuran. The addition solution was added dropwise to the sodium hydride solution over a period of 2 hrs. After two hrs, the solution was cooled to 78° C. and the flask was equipped with a −78° C. reflux condenser. To this solution was added 107 g (918.69 mmol) of CF₂═CFCl through a gas dispersion tube. The solution was allowed to react at −78° C. for 2 hrs and allowed to warm to room temperature over a 12 hr period. After 12 hrs, the solution was cooled to 0° C. and 200 ml of deionized water was added dropwise. The resulting solution was extracted with ether, the ether removed, and the resulting viscous liquid distilled under vacuum to give the desired product. The yield of the desired product was 80.1%, 45.4 g (178.04 mmol). IR (cm⁻¹) (neat, NaCl cell): 2968 (m), 2902 (w), 1760 (m), 1460 (m), 1394 (s), 1368 (s), 1295 (s), 1247 (s), 1190 (s), 1153 (s), 1081 (s), 908 (m), 850 (s), 806 (s), 738 (m), 690 (m).

### Example 3b

### Copolymerization of CFCl═CF—OCH₂CH₂O—CF═CFCl with CF₂═CFCl

To a 50 ml Whitey double-ended stainless steel cylinder was placed 2.16 g (7.37 mmol) CFCl═CF—OCH₂CH₂O—CF═CFCl and 0.1368 g (0.56 mmol) VAZO®-88. The cylinder was frozen at −196° C. and evacuated. The cylinder was allowed to warm to room temperature and the freeze-pump-thaw cycle repeated two additional times. The purpose of freeze-pump-thaw was to remove oxygen from the system. Chlorotrifluoroethylene, 9 g (77.27 mmol), was vacuum transferred to the cylinder at −196° C. The cylinder was heated to 115° C. for 2 days on a shaker. After 2 days the volatiles were vented. The resulting solution was precipitated by addition of 50 ml methanol, the polymer filtered, and dried under vacuum at 60° C. to give 0.31 g of a white polymer. The resulting polymer showed the disappearance of the vinyl peak at 1758. DSC showed that the polymer underwent a melt at 120.6° C. IR (cm⁻¹) (neat, NaCl cell): 2948 (w), 2870 (w), 1457 (w), 1378 (w), 1366 (w), 1286 (s), 1248 (m), 1191 (s), 1126 (s), 1043 (m), 1033 (m), 971 (s), 902 (m), 873 (w), 825 (w), 807 (w), 666 (w), 652 (w), 630 (w), 586 (w), 496 (w).

### Example 4a

### Manufacture of CFCl═CF—OCH₂CH₂OCH₂CH₂O—CF═CFCl

In a three neck 1 L round bottom flask equipped with an addition funnel and a mechanical stirrer was placed 600 ml of dry tetrahydrofuran and 11.31 g (471.3 mmol) of sodium hydride. To the addition funnel was placed 18.8 g (177 mmol) anhydrous HOCH₂CH₂OCH₂H₂OH dissolved in 20 ml of dry tetrahydrofuran. The addition solution was added dropwise to the sodium hydride solution over a period of 2 hrs. After two hrs, the solution was cooled to—78° C. and the flask was equipped with a −78° C. reflux condenser. To this solution was added 70 g (601 mmol) of CF₂═CFCl through a gas dispersion tube. The solution was allowed to react at −78° C. for 2 hrs and allowed to warm to room temperature over a 12 hr period. After 12 hrs, the solution was cooled to 0° C. and 200 ml of deionized water was added dropwise. The resulting solution was extracted with ether, the ether removed, and the resulting viscous liquid distilled under vacuum to give three fractions containing the mono, disubstituted, and hydrogen analogs. The yield of the desired product was 31%, 16.54 g (55.5 mmol), IR (cm⁻¹) (neat, NaCl cell): 2968 (m), 2903 (m), 1762 (m), 1459 (m), 1394 (s), 1368 (s), 1295 (s), 1247 (s), 1187 (s), 1152 (s), 1081 (s), 908 (m), 850 (s), 806 (s), 738 (m), 690 (m).

### Example 4b

### Polymerization of CFCl═CF—OCH₂CH₂OCH₂CH₂O—CF═CFCl

To a 10 ml glass sample cylinder equipped with a TEFLON® valve and a magnetic stirrer was placed 2.23 g (8.75 mmol) CFCl═CF—OCH₂CH₂OCH₂CH₂O—CF═CFCl and 0.0359 g (0.22 mmol) AIBN (2,2′ azobisisobutyronitrile, also called VAZO®-64). The cylinder was frozen at 196° C. and evacuated. The cylinder was allowed to warm to room temperature and the freeze-pump-thaw cycle repeated two additional times. The purpose of freeze-pump-thaw was to remove oxygen from the system. The cylinder was placed in an oil bath at 90° C. and for 48 hs. The resulting solution was precipitated by addition of 10 ml methanol and the polymer dried under vacuum at 60° C. to give 0.01 g of an off-white crystalline polymer. The resulting polymer showed the disappearance of the vinyl peak at 1761. Using thermal gravimetric analysis, the polymer showed 10% weight loss temperature of about 165° C. under nitrogen when heated at 10° C./minute.

The monomers and polymers described in this invention are useful in both active and passive polymer photonic devices. These materials can also be used to modify the index of refraction of an optical material.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the claims.

What is claimed is:

1. A compound of formula I:
R₁—(CX₄X₅)ₙ—(CX₆X₇)ₘ—(CX₈X₉)ₚ—(CX₁₀X₁₁)_{q}—R₂ (I)
where:
R₁ is X₂X₃C═CX₅— or X₁X₂X₃C—CX₄X₅—;
R₂ is —X₁₁C═CX₁₂X₁₃, —X₁₀X₁₁CH₂—CX₁₂ CX₁₂X₁₃X₄, F, Cl, Br or H;
wherein:
(a) X₁-X₁₄ can be the same or different and are chosen from F, Cl, Br and H, and one of X₂, X₃, X₅, X₆ or X₇ is not F, or one of X₈, X₉, X₁₁, X₁₂ or X₁₃ is not H;
(b) n, m, p and q can be the same or different and are integers from 0 to 3, with the proviso that at least one of n, m, p, or q, is not equal to zero; and
(c) at least one of R₁ or R₂ is unsaturated.

2. The compound of claim 1 where formula (1) is CF₂═CFCH₂CF₂CH₂CF═CF₂.

3. A compound of formula II:
R₁—(CX₄X₅)ₙ—(CX₁₅X₁₆)ₘ—(CX₈X₉)ₚ—Z—(CX₁₀X₁₁)_{q}—R₂ (II)
where:
R₁ is X₂X₃C═CX₅— or X₁X₂X₃C—CX₄X₅—;
R₂ is —X₁₁C═CX₁₂X₁₃, —X₁₀X₁₁CH₂—CX₁₂X₁₃X₁₄′, —CX₁₂X₁₃X₁₄, F, Cl, Br or H;
wherein:
(a) X₁, X₂, X₃, X₄, X₅, X₈, X₉, X₁₀, X₁₁, X₁₂, X₁₃, X₁₄ can be the same or different and are chosen from F, Cl, Br and H;
(b) m, p and q can be the same or different and are integers from 0 to 3;
(c) n is 1, 2 or 3;
(d) X₁₅ and X₁₆ can be the same or different and are chosen from F, Cl, Br, H and CF₃; and
(e) Z is chosen from Oxygen (O), Sulfur (S), Selenium (Se), and Tellurium (Te).

4. The compound of claim 3 wherein:
(a) X₁₅ and X₁₆ are F;
(b) m=1, 2 or 3; p=1; q=n=0;
(c) X₈ and X₉ can be the same or different and are chosen from H, F and Cl;
(d) R₁ is X₂X₃C═CX₅ — or X₁X₂X₃C—CX₄X₅— where X₂, X₃, and X₅═F, and X₁ and X₄═Cl; and
(e) R₂ is —X₁₁C═CX₁₂X₁₃ where X₁₁ and X₁₂ are F, and X₁₃ is Br or Cl.

5. The compound of claim 3 wherein formula (II) is
HCF₂(CF₂)₃CH₂OCF═CFCl.

6. The compound of claim 3 wherein formula (II) is
CF₂═CF(CF₂)₂CH₂OCF═CFCl.

7. A compound of formula III:
R₁—Z—(CX₁₅X₁₆)ₙ—(CX₈X₉)ₘ—(CX₁₀X₁₁)ₚ—Z—R₂ (III)
where:
R₁ is X₂X₃C═CX₅— or X₁X₂X₃C—CX₄X₅—;
R₂ is —X₁₁C═CX₁₂X₁₃, —X₁₀X₁₁CH₂—CX₁₂X₁₃X₁₄, —CX₁₂X₁₃X₁₄, F, Cl, Br or H;
wherein:
(a) X₁, X₂, X₃, X₄, X₅, X₈, X₉, X₁₀, X₁₁, X₁₂, X₁₃, X₁₄ can be the same or different and are chosen from F, Cl, Br and H;
(b) X₁₅ and X₁₆ are the same or different and are chosen from F, Cl, Br, H and CF₃;
(c) n, m, and p can be the same or different and are integers from 0 to 3.
(d) Z is chosen from O, S, Se, and Te.

8. The compound of claim 7 wherein:
(a) n=1;
(b) m=p=0; and
(c) X₁₅ and X₁₆ can be the same or different and are chosen from Cl, Br or H, or X₁₂ and X₁₃ are the same and are chosen from CH₃, Cl, Br or H.

9. The compound of claim 7 wherein formula (III) is
CClF═CF—O(CH₂)₂O—CF═CClF.

10. The compound of claim 7 wherein formula (III) is
CF₂═CF—O(CH₂)₂O—CF═CF₂.

11. The compound of claim 7 wherein formula (III) is
CF₂═CH—O(CH₂)₂O—CH═CF₂.

12. A compound of formula IV:
R₁—(CX₄X₅)ₙ—Z—(CX₆X₇)ₘ—Z—(CX₈X₉)ₚ—Z—(CX₁₀X₁₁)_{q}—R₂ IV)
where:
R₁ is X₂X₃C═CX₅— or X₁X₂X₃C—CX₄X₅—;
R₂ is —X₁₁C═CX₁₂X₁₃, —X₁₀X₁₁CH₂—CX₁₂X₁₃X₁₄, —CX₁₂X₁₃X₁₄, F, Cl, Br or H;
wherein:
(a) X₁-X₁₄ can be the same or different and are chosen from F, Cl, Br and H;
(b) X₁₅ and X₁₆ can be the same or different and are chosen from F, Cl, Br, H and CF₃; (c) n, m, p and q can be the same or different and are integers from 1 to 3; and
(d) Z is chosen from O, S, Se, and Te.

13. The compound of claim 12 where formula (IV) is
CFCl═CF—OCH₂CH₂OCH₂CH₂O—CF═CFCl.

14. A polymer comprising at least one monomer chosen from a compound from formula (I), R₁ (CX₄X₅)ₙ—(CX₆X₇)ₘ—(CX₈X₉)ₚ—(CX₁₀X₁₁)_{q}—R₂, formula (II), R₁ (CX₄X₅)ₙ—(CX₁₅X₁₆)ₘ—(CX₈X₉)ₚ—Z—(CX₁₀X₁₁)_{q}—R₂, formula (III), R₁—Z—(CX₁₅X₁₆)ₙ—(CX₈X₉)ₘ—(CX₁₀X₁₁)ₚ—Z—R₂, and formula (IV), R₁—(CX₄X₅)ₙ—Z—(CX₆X₇)ₘ—Z—(CX₈X₉)ₚ—Z—(CX₁₀X₁₁)_{q}—R₂.

15. The polymer of claim 14 further comprising a compound from formula (I), formula (II), formula (III), formula (IV), or compounds containing phosphorous.

16. The polymer of claim 15 wherein said compounds containing phosphorous include phosphinic acid, phosphonic acid, and phosphates.

17. The polymer of claim 14 further comprising tetrafluoroethylene, hexafluoropropylene, vinylidene fluoride, perfluoro (methyl vinyl ether), perfluoro (propyl vinyl ether), methyl vinyl ether, propylene, ethylene, chlorotriflouroethylene, vinyl fluoride, vinyl chloride, trifluoroethylene, perfluoro (2, 2-dimethyl-l, 3-dioxole), CF₂═CF(CF₂)ₘOCF═CF₂, where m=1, 2 or 3, and omega-alkenyl vinyl ethers.

18. The polymer of claim 14 wherein the polymer is linear, cyclic, branched, hyperbranched, dendritic, crosslinked, random, block or graft.

19. A method of making the polymer of claim 14 comprising
(a) admixing an initiator, and at least one first monomer which is chosen from formula (I), formula (II), formula (III), and formula (IV);
(b) heating for 1-5 days at a temperature of 25-200° C.; and
(c) recovering the polymer;
whereby oxygen is removed prior to the start of the reaction.

20. The method of claim 19 wherein a solvent is admixed with the initiator and at least one first monomer which is chosen from formula (I), formula (II), formula (III), and formula (IV).

21. The method of claim 20 wherein the solvent is chosen from (1,1,2-trichloro-1,2,2-trifluoroethane), t-butanol, water, toluene, methanol, perfluorotributylamine, perfluorotrihexylamine, perfluorotripentylamine, perfluorotripropylamine, and 1,2-dichlorohexafluoropropane.

22. The method of claim 19 wherein a second monomer which is different from said first monomer is admixed with the initiator and at least one first monomer which is chosen from formula (I), formula (II), formula (III), and formula (IV).

23. The second monomer of claim 22 wherein the monomer is chosen from compounds containing phosphorous.

24. The monomer of claim 23 wherein said compounds containing phosphorous include phosphinic acid, phosphonic acid, and phosphates.

25. The second monomer of claim 22 wherein the monomer is chosen from tetrafluoroethylene, hexafluoropropylene, vinylidene fluoride, perfluoro (methyl vinyl ether), perfluoro (propyl vinyl ether), methyl vinyl ether, propylene, ethylene, chlorotriflouroethylene, vinyl fluoride, vinyl chloride, trifluoroethylene, perfluoro (2, 2-dimethyl-l, 3-dioxole), CF₂═CF(CF₂)ₘOCF═CF₂, where m=1, 2 or 3, or omega-alkenyl vinyl ethers.

26. The method of claim 19 wherein the initiator is chosen from 1, 1′-azobis(cyclohexanecarbonitrile), 2,2′-azobisisobutyronitrile, 2,2′-azobis (2,4-dimethylpentanenitrile), 2,2′-Azobis(2-methylbutyronitrile), 2,2′-azobis[2-(2-imidazolin-2-yl)propane]dichloride, tert-Amyl peroxybenzoate, 4,4-Azobis(4-cyanovaleric acid), 1,1′-Azobis (cyclohexanecarbonitrile), Benzoyl peroxide, 2,2-Bis(tert-butylperoxy)butane, 1,1-Bis(tert-butylperoxy)cyclohexane, 2,5-Bis(tert-butylperoxy)-2,5-dimethylhexane, 2, 5-Bis(tert-Butylperoxy)-2,5-dimethyl-3-hexyne, Bis(1-(tert-butylperoxy)-1-methylethyl)benzene, 1,1-Bis(tert-butylperoxy)-3,3,5-trimethylcyclohexane, tert-Butyl hydroperoxide, tert-Butyl peracetate, tert-Butyl peroxide, tert-Butyl peroxybenzoate, tert-Butylperoxy isopropyl carbonate, Cumene hydroperoxide, Cyclohexanone peroxide, Dicumyl peroxide, Lauroyl peroxide, 2,4-Pentanedione peroxide, Peracetic acid, Potassium persulfate, 2,2′-azobis[4-methoxy-2,4-dimethylvaleronitrile], 2,2′-azobis[2,4-dimethylvaleronitrile], 2,2′-azobis[2-methylpropionitrile], 2,2′azobis[2-methylbutyronitrile], 1-[(1-cyano-1-methylethyl)azo]formamide, 2,2′-azobis{2-methyl-N-{1,1-bis(hydroxymethyl)-2-hydroxyethyl]propionamide, 2,2′-azobis[2-(5-methyl-2-imidazolin-2-yl)propane]dihydrochloride, 2,2′azobis(2-methylpropionamidoxime), and dimethyl 2,2′-azobisisobutyrate,

27. The second monomer of claim 22 wherein the monomer further comprises at least one metal chosen from aluminum (Al), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb).

28. The method of claim 19 whereby said heating is performed for 1-4 days.

29. The method of claim 19 whereby said heating is performed for 2-3 days.

30. The method of claim 19 whereby said temperature is at temperature of reflux.

31. The method of claim 19 whereby said temperature is between 25-200° C.

32. The method of claim 19 whereby said temperature is between 50-150° C.

33. The method of claim 19 whereby said temperature is between 90-115° C.

34. The method of claim 19 whereby said recovering is performed by precipitation, filtration, extraction, centrifugation, drying, vacuum drying, or any combination thereof.

35. The method of claim 19 whereby the oxygen removal is performed using at least one freeze-pump-thaw cycle.

36. The method of claim 19 whereby the oxygen removal is performed using at least two freeze-pump-thaw cycles.

37. A method of making CF₂═CFCH₂CH₂CH₂CH₂CF═CF₂ comprising:
(a) admixing magnesium and iodine in an inert solvent and stirring for up to about 30 minutes;
(b) admixing CF₂═CFCH₂CH₂Br;
(c) heating to reflux for up to 2 days;
(d) admixing an aqueous solution; and
(e) recovering CF₂═CFCH₂CH₂CH₂CH₂CF═CF₂.

38. A method of making CF₂═CFCF₂CF₂CH₂OCF═CFCl comprising:
(a) stirring sodium hydride in an inert solvent;
(b) admixing H(CF₂)₄CH₂OH;
(c) cooling to less than −50° C.;
(d) admixing CF₂═CFCl;
(e) warming the mixture to at least about 0° C.;
(f) adding an aqueous solution;
(g) recovering an intermediate H(CF₂)₄CH₂OCF═CFCl;
(h) adding said intermediate to an inert solvent;
(i) admixing t-butyl lithium;
(j) reacting for up to 2 hours at room temperature;
(k) admixing an aqueous solution; and
(l) recovering CF₂═CFCF₂CF₂CH₂OCF═CFCl.

39. A method of making CFCl═CF—OCH₂CH₂O—CF-CFCl comprising:
(a) stirring sodium hydride in an inert solvent;
(b) admixing HOCH₂CH₂OH;
(c) cooling to less than −50° C.;
(d) admixing CF₂═CFCl;
(e) warming the mixture to at least about 0° C.;
(f) admixing an aqueous solution; and
(g) recovering CFCl═CF—OCH₂CH₂O—CF—CFCl.

40. A method of making CFCl═CF—OCH₂CH₂OCH₂CH₂O—CF═CFCl comprising:
(a) stirring sodium hydride in an inert solvent;
(b) admixing HOCH₂CH₂OCH₂H₂OH;
(c) cooling to less than −50° C.;
(d) admixing CF₂═CFCl;
(e) warming the mixture to at least about 0° C.;
(f) admixing an aqueous solution; and
(g) recovering CFCl═CF—OCH₂CH₂OCH₂CH₂O—CF═CFCl.
